(19) United States
(12) Patent Application Publication
(10) Pub. No.: US 2025/0161875 A1
(43) Pub. Date: May 22, 2025

(54) SYSTEM AND METHOD FOR CAPTURE AND UTILIZATION OF CARBON DIOXIDE FROM DILUTE FLUID STREAMS

(71) Applicant: Coldstream Energy IP, LLC, Houston, TX (US)

(72) Inventor: Jason G. S. Ho, Houston, TX (US)

(73) Assignee: Coldstream Energy IP, LLC, Houston, TX (US)

(21) Appl. No.: 18/865,060

(22) PCT Filed: May 16, 2023
(86) PCT No.: PCT/US2023/067060

§ 371 Date: Nov. 12, 2024

Related U.S. Application Data
(60) Provisional application No. 63/342,787, filed on May 17, 2022.

(51) Int. Cl. B01D 53/62; B01D 33/06; B01D 37/00; B01D 53/78

(52) U.S. Cl. CPC B01D 53/62; B01D 33/06; B01D 37/00; B01D 53/78; B01D 2251/30; B01D 2252/1035; B01D 2257/504; B01D 2258/01

(57) ABSTRACT

A system and method for capture and utilization of carbon dioxide from dilute fluid streams. A method of capturing and utilizing carbon from a dilute post-combustion gas stream includes homogenizing a dilute CO2 gas stream with a fluid solvent in a static mixer to produce a homogenized gas-liquid mixture, applying an electric current to the homogenized gas-liquid mixture to increase the pH of the homogenized gas-liquid mixture and produce a slurry including carbonate, bicarbonate or a combination thereof, filtering the carbonate, bicarbonate or combination thereof from the slurry, and calcinating the recovered bicarbonate to form soda ash or pearl ash.

### BACKGROUND

### 1. Field of the Invention

Embodiments of the invention described herein pertain to the field of carbon capture from post-combustion fluid streams. More particularly, but not by way of limitation, one or more embodiments of the invention enable a system and method for capture and utilization of carbon dioxide from dilute fluid streams.

### 2. Description of the Related Art

Society requires vast amounts of energy to function, since the consumption of energy is tied intricately with heating, cooking, production of goods, delivery of services, and transportation of people, goods, and services. While the demand for energy is ever increasing, there is growing awareness for the need to diversify our energy sources and to balance consumption with conservation and sustainable stewardship for future generations. This awareness and continued technological advancement has been a catalyst for the growth and increasing integration of alternative, yet intermittent energy sources available to the world, such as wind and solar. Renewable energy resources, for example, frequently depend on the environment in which they are placed: solar energy requires direct sunlight, wind energy requires wide open spaces and strong winds. As a result, these renewable energy sources are typically suited to specific microenvironments or geographies. With the increasing utilization of these types of energy resources, there has been a shift in the scale of energy production from large-scale power plants to localized, distributed generation and microgrid energy solutions.

Distributed energy solutions produce and supply energy on a small scale and are spread out over a wide area. Rooftop solar panels and emergency diesel/natural gas generators are examples of current distributed energy solutions. In contrast to traditional power plants which are connected to the high-voltage transmission grids, low-voltage distribution grids (e.g., residences, businesses) on the other hand, are connected to distributed energy sources.

Microgrids are localized electric grids that can disconnect from the main grid to operate autonomously. Because they can operate while the main grid is non-operational, microgrids can strengthen grid resilience, help mitigate grid disturbances, and function as a grid resource for faster system response and recovery. While there is a shift in scale for power production due to the growth of renewables, most of the focus on environmental stewardship in the context of emissions is focused on large-scale power plants or large-scale industrial sources, probably due to the benefits of economies of scale.

Whether discussing large-scale or small-scale energy production, global or local energy production, most of the energy consumed worldwide is still produced by the combustion of carbon-based fossil fuels, such as oil, natural gas, coal, and biomass. This combustion releases a large amount of greenhouse gasses that are harmful to the environment including carbon dioxide (CO₂). CO₂ emissions are associated with climate change which has been observed to be related to changes in sea level and species extinctions. These environmental changes will cost trillions of dollars to mitigate if they are not addressed promptly. One way to reduce these harmful and expensive effects is to reduce or permanently remove CO₂ from the environment. Therefore, there is tremendous potential and need to address CO₂ emissions from dilute sources that are not considered large-scale point sources, such as traditional power plants.

Traditionally, post-combustion carbon capture technologies, especially in relation to power generation, are expensive and reduce power generation efficiency, resulting in lower power production capacity, increased fuel demand, and increased power costs to meet electricity demand. The major challenges in reduction or removal of carbon dioxide emissions revolve around the relatively large parasitic load imposed on a power plant to capture these emissions, especially the energy needed to regenerate the solvent used for emissions capture. Energy required for compression, though important, is less than that required for capture and is closer to its thermodynamic limit than capture is to its thermodynamic limit. In general, capital cost reductions, minimizing solvent degradation, reducing solvent volatility, and other such parameters are secondary to the prime issue of reduction in parasitic load on the host power plant imposed by the post-combustion CO₂ capture process itself. These secondary issues, while important, do not constitute the major challenge, and therefore much of the research and development trend is focusing on the reduction in parasitic load of CO₂ capture processes.

To take a step back, the deployment of carbon capture in industrial processes dates back to the 1930s, when carbon dioxide absorption with chemical solvents, such as amines in aqueous solutions, were used in the natural gas industry to separate CO₂ from methane. Starting in the 1940s, processes using physical solvents emerged for CO₂ capture from process gas streams that contained CO₂ concentrations of 25-70% and under approximately 100 bar (10,000 kPa) of pressure. Two commercial examples of physical solvents are Selexol® (a trademark of Union Carbide Corporation of NY) and Rectisol® (a trademark of Air Liquide Global E&C solutions Germany GMBH of Germany). These solvents are currently used at gasification plants using coal, petroleum coke, and biomass feedstocks. In the 1950s and 1960s, adsorption processes using solid sorbents, such as pressure swing adsorption (PSA) systems, enabled gas separation in hydrogen production, nitrogen production, and dehydration applications. In the 1970s and 1980s, membranes were developed to capture CO₂ for use in natural gas processing. However, applying traditional carbon capture technologies to decarbonize industries with low-concentration dilute gas streams, such as the power sector, is costlier due to the laws of thermodynamics. To further elaborate, by capturing/separating CO₂ molecules from a dilute source, one is reducing the entropy of that source. And roughly speaking, entropy is a measurement of the disorder of the all the molecules in that source. By separating the CO₂, one has arranged the molecules in a more orderly state, i.e. the entropy of the system has decreased. This change in entropy can be calculated without even knowing the machine or mechanism by which the separation occurs. This entropy change depends on what happened, not how it happened. And since the initial and final state of the dilute source, such as air or flue gas, is known—mixed vs. separated—the change in entropy can be calculated. The second law of thermodynamics states that entropy always increases, but if one tries to reduce entropy, then the cost to create more order is to expend greater amounts of energy/work. And the more dilute the desired species that needs to be captured, the greater the energy cost required. And this energy increases exponentially as the concentration of desired concentration approaches zero. This makes conventional carbon capture or concentration of carbon in dilute concentrations unavoidably expensive and inefficient.

TABLE 1
Typical composition of flue gases

| Gas Constituent | Coal | Natural Gas |
|---|---|---|
| Nitrogen | 70-75% | 73-76% |
| Carbon dioxide | 10-15% | 4-5% |
| Water vapor | 8-15% | 8-10% |
| Oxygen | 3-4% | 12-15% |
| Trace gases (SOx, NOx, others) | <1% | <1% |

As is apparent from Table 1, the concentration of CO₂ in flue gases from the combustion of natural gas may be as little as 4-5%, and the concentration of CO₂ in flue gases from the combustion of coal is typically in the range of 10-15%. As used herein, these are considered “dilute” fluid streams.

Absorption refers to the uptake of CO₂ into the bulk phase of another material—for example, dissolving CO₂ molecules into a liquid solution such as an aqueous amine. Absorption is used widely in the chemical, petrochemical, and other industries, and as a result, operational confidence in absorption process is high. In a solvent-based carbon capture process, flue gas is contacted with the solvent which typically contains a reagent that selectively reacts with CO₂. This contact occurs in traditional gas-liquid contactors, and CO₂ transfers from the gas phase into the liquid phase. The CO₂-loaded rich solution is pumped to a regenerator vessel where it is heated to liberate gaseous CO₂ and the lean solution is circulated back to the absorber. While the high specificity of the reagents means that the captured CO₂ is of high purity, this CO₂ still needs to be collected, dried, compressed, and transported to a storage reservoir. Because of the specificity and selectivity of the reagents used for CO₂ capture, there is a corresponding high energy cost to recover and regenerate these reagents for re-use.

For example, the most common example of a chemical absorption process is 30 wt % aqueous monoethanolamine (MEA) which has been used commercially and captures up to 1000 tonne/day of CO₂. Current estimates of capture with MEA followed by compression for underground storage impose approximately 30% parasitic load on the net output of a power plant and increase the cost of electricity by 60-90%. These relatively high values result from the relatively large quantity of energy needed to regenerate the solvent. Therefore, much of the current research in absorption-based CO₂ removal is focused on the development of new solvents that reduce the regeneration energy. Additionally, the presence of oxygen, sulfur oxides, and nitrogen oxides in the exhaust (flue gas) cause problems for amine-based technologies due to the formation of heat stable salts such as amine sulfates and nitrates.

Adsorption, as opposed to absorption, refers to uptake of CO₂ molecules onto the surface of another material—for example, adhering CO₂ molecules onto the surfaces of a solid sorbent such as a zeolite. An advantage of adsorption is that the regeneration energy should be lower relative to solvents since the heat capacity of the solid sorbent is lower than aqueous solvents and the specificity of the adsorbent surface is less than a chemical absorbent reaction. Potential disadvantages for adsorbents include particle attrition, handling of large volumes of sorbent and thermal management of large-scale adsorber vessels.

Adsorption typically occurs via weak Van der Waals forces for physisorption, or stronger covalent bonding for chemisorption. Adsorption processes are implemented most often with the adsorbent used in packed beds or fluidized beds. In a packed bed, adsorbent is loaded into a column, flue gas flows through the pore spaces between the adsorbent particles, and the CO₂ adsorbs onto the particle surfaces. In fluidized beds, flue gas flows upward through a column at velocities such that the adsorbent particles are suspended in the gas flow. Regardless of the process configuration, the adsorbent selectively adsorbs CO₂ from the flue gas, and is subsequently regenerated by lowering the pressure and/or increasing the temperature to liberate the adsorbed CO₂. In many packed bed configurations, regeneration is accomplished by heating the CO₂-laden adsorbent to liberate CO₂. During this time, flue gas is diverted to a second packed bed which continues to adsorb CO₂ from the gas. By alternating flue gas between two packed beds that alternatively undergo absorption and regeneration in a cycle, CO₂ can be continually removed from flue gas. In a fluidized bed, the sorbent is circulated between an absorber vessel where it contacts flue gas and a regenerator vessel where it is heated to liberate gaseous CO₂.

Technological advances to adsorption processes are primarily focused on the development of entirely new materials that may have higher specificity or affinity for CO₂, such as metal organic frameworks (MOFs), zeolites and zeolitic imidazolate frameworks (ZIFs) but are still mostly confined to academic institution levels of development and not yet economically scalable for commercial application due to the high cost of these specialized adsorbent materials.

Membranes are another technology that has been considered to separate CO₂ from flue gas by selectively permeating it through the membrane material. If CO₂ has a higher permeability (permeability, defined as the product of solubility and diffusivity, in the membrane relative to other species in the flue gas) then CO₂ will selectively permeate the membrane. In some cases, chemical agents that selectively react with CO₂ are also added to the membrane to increase the membrane's selectivity for CO₂. CO₂ permeates through a membrane only if its partial pressure is higher on one side of the membrane relative to the other side. This partial pressure gradient can be obtained by pressurizing the flue gas on one side of the membrane and applying a vacuum on the other side of the membrane. Depending on the selectivity of the membrane, multiple membrane stages may be needed in order to obtain sufficiently high CO₂ purity.

Like adsorbents, membranes potentially offer capture processes that require less energy compared to absorption, because the need to regenerate solvents is removed and the specificity/selectivity of the membrane may be less than that of a solvent. Additional benefits could include a smaller foot-print for the capture system and a modular design that may allow for flexible operation. The problem with membranes is the potential fouling of the membrane surfaces from particulate matter, uncertainty about the performance and cost of large-scale efficient vacuum pumps and compressors required for multiple membrane stages, and the ability to integrate the process into large point sources. Membrane processes are in general less widely used for separations, and therefore as a class, are also further from commercialization as well. Developments around membranes for post-combustion carbon dioxide capture are still in the laboratory stages, focusing chiefly on improving the membrane material properties.

Currently, most technological research is focused on absorption as a solution for carbon capture, with adsorption and membranes to a lesser extent. Currently, absorption dominates the near-term, higher technology readiness levels. However, these near-term technologies will also tend to be ones with higher parasitic load.

Colloquially, the Solvay process has been used to convert CO₂ to soda ash (sodium carbonate) since the 1860s. In the conventional Solvay process, gaseous CO₂ and ammonia gas are passed through a saturated sodium chloride solution to form soluble ammonium chloride and a precipitate of sodium bicarbonate. The sodium bicarbonate is then heated to form soda ash. One of the major drawbacks of the Solvay process is the presence of ammonia, which is considered an environmental and health hazard. Ammonia does not react in the Solvay process, but instead acts as a buffer to maintain the solution at a basic pH in order to drive the precipitation of sodium bicarbonate. Apart from safety concerns of handling ammonia gas, the recovery and regeneration of ammonium chloride to ammonia gas, much like amine regeneration, is the energy intensive step that adds to the overall cost of the process.

As is apparent from the above, current technologies for removing CO₂ from dilute gas streams produced during fuel combustion suffer from many drawbacks, and capturing CO₂ is necessary for the reduction of greenhouse gas emissions into the environment. Therefore, there is a need for a system and method for capture and utilization of carbon dioxide from dilute fluid streams.

### SUMMARY

One or more illustrative embodiments enable a system and method for capture and utilization of carbon dioxide from dilute fluid streams.

A system and method for capture and utilization of carbon dioxide from dilute fluid streams is described. An illustrative embodiment of a carbon capture system includes a static mixer fluidly coupled to a dilute CO₂ stream and a fluid solvent, wherein the static mixer is configured to produce a homogenous mixture from the dilute CO₂ stream and the fluid solvent, means for increasing the pH of the homogenous mixture to at least 8, thereby producing a slurry from the homogenous mixture, the slurry including one of bicarbonate, carbonate or a combination thereof, a filtration system applied to the slurry that recovers precipitate from the slurry, and a calcination system configured to convert the precipitate into an ash. In some embodiments, the dilute CO₂ stream includes exhaust exiting a fuel gas combustion chamber. In certain embodiments, the carbon capture system includes a compressor fluidly coupled to the static mixer and configured to compress the dilute CO₂ stream prior to entry into the static mixer. In some embodiments, the carbon capture system further includes a heat engine coupled between the fuel gas combustion chamber and the compressor, wherein the heat engine extracts work from the dilute CO₂ stream to power the compressor. In certain embodiments, the carbon capture system includes a heat recovery system coupled between the fuel gas combustion chamber and the compressor, wherein heat from the dilute CO₂ stream is used to calcinate the precipitate and form one of either soda ash or pearl ash. In certain embodiments, the static mixer further includes a housing and baffles dispersed within the housing. In some embodiments, the filtration system further includes a rotary drum filter. In certain embodiments, the means for increasing the pH of the homogenous mixture includes an electrolysis system. In some embodiments, the means for increasing the pH of the homogenous mixture includes adding an alkali caustic to the homogenous mixture. In certain embodiments, the fluid solvent includes one of fresh water, sea water, a salty aqueous solution, a brine or a combination thereof. In some embodiments, the ash includes soda ash or pearl ash.

An illustrative embodiment of a method of capturing and utilizing carbon from a dilute post-combustion gas stream includes homogenizing in a static mixer a dilute CO₂ gas stream and a fluid solvent to produce a homogenized gas-liquid mixture, applying an electric current to the homogenized gas-liquid mixture to increase a pH of the homogenized gas-liquid mixture and thereby produce a slurry including one of carbonate, bicarbonate, or a combination thereof, filtering the one of carbonate, bicarbonate or a combination thereof from the slurry, and calcinating the filtered carbonate, bicarbonate or the combination thereof to produce one of soda ash or pearl ash. In some embodiments, the dilute CO₂ gas stream is produced from combustion of a carbon-based fuel to produce power. In some embodiments, the combustion produces waste heat, and wherein the waste heat is applied to power the filtering. In certain embodiments, a heat engine applies the waste heat to power the filtering. In some embodiments, the dilute CO₂ stream is compressed prior to homogenizing. In certain embodiments, the dilute CO₂ stream includes exhaust from carbon-based fuel combustion, and further including extracting heat from the dilute CO₂ gas stream to power one of a compressor, a continuous filtration system, calcination, or a combination thereof. In some embodiments, the method further includes utilizing a compressor to compress the dilute CO₂ gas stream prior to homogenizing the dilute CO₂ gas stream in the static mixer, and further includes extracting heat from the dilute CO₂ gas stream to power the compressor. In certain embodiments, filtering the slurry produces a second fluid solvent, and further including recirculating the second fluid solvent into the static mixer. In some embodiments, filtering includes extracting the one of carbonate, bicarbonate or the combination thereof from the slurry by using a rotating vacuum drum to form filter cake and converting the filter cake into one of soda ash or pearl ash. In certain embodiments, the fluid solvent includes one of fresh water, salt water, sea water, brine or a combination thereof. In some embodiments, the fluid solvent is a salty aqueous solution. In certain embodiments, the fluid solvent is fresh water.

An illustrative embodiment of a method of capturing and utilizing carbon from a post-combustion gas stream includes mixing the post-combustion gas stream with a brine in a static mixer, increasing the pH of the post-combustion gas stream and the brine so mixed to produce a precipitate, and filtering the precipitate from the mixture. In some embodiments, increasing the pH includes addition of an alkali caustic to the mixture. In certain embodiments, increasing the pH includes applying electrolysis to the gas stream and brine mixture. In some embodiments, electrolysis includes placing a semi-permeable membrane to surround an anode but not a cathode.

An illustrative embodiment of a carbon capture method includes mixing a dilute CO₂ stream and an aqueous solution to form a slurry, the slurry including one of bicarbonate, carbonate or a combination thereof, filtering the slurry to form a precipitate and a filtrate from the slurry, and calcinating the precipitate to convert the precipitate into an ash. In some embodiments, the aqueous solution has a high pH. In certain embodiments, the carbon capture method further includes recirculating the filtrate to combine with the aqueous solution. In some embodiments, the carbon capture method further includes increasing the pH of the filtrate prior to recirculating the filtrate to combine with the aqueous solution.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings in which:

FIG. 1 is a schematic diagram of a carbon capture system of illustrative embodiments.

FIG. 2 is a chart illustrating the forms of CO₂ in aqueous solution as a function of pH.

FIG. 3 is a chart illustrating the solubility of CO₂ in salt water as a function of salinity and temperature.

FIG. 4A is a perspective view of a static mixer of illustrative embodiments with part cut away.

FIG. 4B is a cross sectional view of a static mixer of illustrative embodiments.

FIG. 5A is a perspective view of a rotary vacuum filter of illustrative embodiments.

FIG. 5B is a schematic diagram of a filtration system of illustrative embodiments including an exemplary rotary vacuum filter.

FIG. 6 is a schematic diagram of a wholistic carbon capture and utilization process of illustrative embodiments.

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives falling within the scope of the present invention as defined by the appended claims.

### DETAILED DESCRIPTION

A system and method for capture and utilization of carbon dioxide from dilute fluid streams will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to a filter includes one or more filters.

As used in this specification and the appended claims, “dilute” means a concentration of 15% or less.

As used in this specification and the appended claims, “precipitate” refers to a precipitate of carbonate, bicarbonate, or a combination of the two.

As used in this specification and the appended claims, “high pH” refers to a pH of 8 or above.

Illustrative embodiments may provide an improved system and method for removing undesirable air emissions resulting from the combustion of fuel for the production of energy. Illustrative embodiments may reduce the parasitic load and costs involved in such removal process, as compared to conventional carbon capture systems such as conventional solvent-based absorption approaches. Illustrative embodiments may provide a wholistic approach of capturing carbon dioxide emissions from fossil fuel combustion, converting the carbon dioxide generated from combustion to a viable commercial product, and also converting the waste heat from combustion to electricity and additional work within this wholistic process of illustrative embodiments.

Illustrative embodiments may provide an improved approach to the capture, concentration, and purification of CO₂. The process of illustrative embodiments may capture and convert CO₂ to soda ash, pearl ash and/or a carbonate salt, thereby removing the CO₂ from the atmospheric carbon cycle. The conversion of CO₂ to carbonate salts of illustrative embodiments after recovery from combustion exhaust may eliminate the need to concentrate or purify CO₂, a problem which has plagued conventional carbon capture systems. Conversion of CO₂ into a commercially viable feedstock and product may remove the CO₂ from the carbon cycle and at the same time may convert what has been conventionally thought of as waste, instead into a useable product.

Illustrative embodiments may provide a wholistic approach to the capture and conversion of CO₂ from dilute, post-combustion fluid streams. The mineralization of carbon into carbonate may be a safe carbon storage mechanism. This carbonate product may be used as a feedstock for making valuable products. Carbonate may also be used commercially for industrial purposes such as detergent, glass manufacture or concrete production. The mineralization of CO₂ from waste may turn what would conventionally be waste into economic benefit and a useful product that may be achieved via direct use of available point source CO₂. Illustrative embodiments may employ multiple streams, which would otherwise be waste, instead to produce a viable commercial product. For example, utilizing brackish or brine effluent associated with industrial processes or produced water from oil and gas production, and combining these streams with CO₂ waste associated with fossil fuel combustion to produce soda ash may transform waste into a viable commercial product. Carbonate-able wastes and CO₂ sources are generally co-located and may provide a unique opportunity to remove CO₂ from the carbon cycle directly and manage both gaseous and liquid waste streams efficiently.

Waste heat recovery from the exhaust gas post-combustion may enhance combustion or energy-use efficiency and may be used to offset potential parasitic loads associated with the CO₂ conversion process, such as any compression, cooling, reagent mixing, or calcination steps. Any parasitic load of rotary drum operation, compression, and/or pumping and calcination may be offset by waste heat recovery from the exhaust gas. Illustrative embodiments may eliminate the need for the dehydration of flue gas post-combustion and the dehydration of purified CO₂ post-concentration, prior to transport.

Illustrative embodiments may employ a modified Solvay process that eliminates the need for gaseous ammonia as a buffering agent, removes the need for a high pH buffered aqueous feed, eliminates the need for limestone as a CO₂ feedstock, maximizes the mass transfer between gas and liquid, eliminates the need for reactor vessels, and removes CO₂ generated from the combustion process. In some embodiments, a dilute CO₂ gas stream may be homogenized with brine in a static mixer and/or an electric current may be applied to the homogenized gas-liquid mixture to increase the pH of the homogenized gas-liquid mixture and produce a bicarbonate slurry. The improvements of illustrative embodiments may reduce the parasitic load by eliminating conventional reactors and columns and may desirably allow elimination of ammonia.

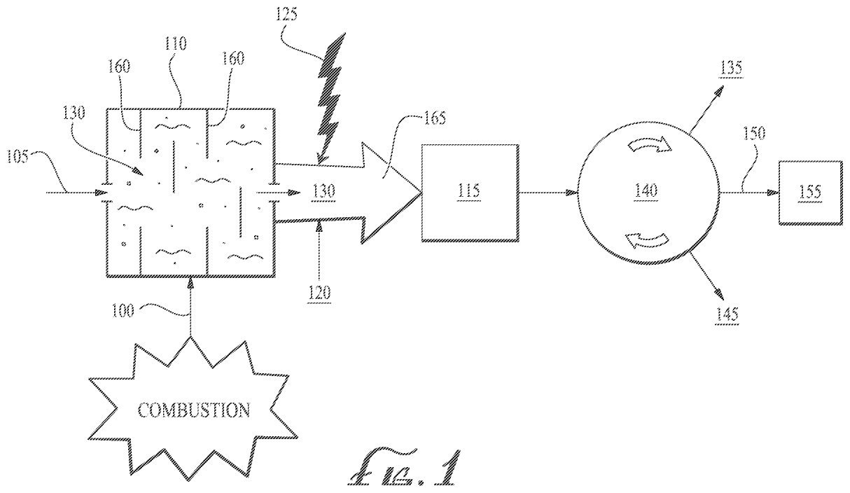

FIG. 1 illustrates an improved carbon capture system of illustrative embodiments. Gas stream 100 may be a post-combustion fluid stream, such as combustion exhaust produced at a power plant and/or flue gas, and may have a dilute concentration of CO₂, such as about 10 mol % CO₂, 5 mol % CO₂ and/or less than 15 mol % CO₂. Gas stream 100 may be combined with fluid solvent 105. Fluid solvent 105 may be a liquid such as fresh water, sea water, salt water, a salty aqueous solution including a salt such as NaCl, CaCl₂) or KCl, NaCl brine, brackish, seawater and/or brine effluent associated with industrial processes or produced water from the oil and gas production.

Mixer 110 may provide simultaneous mixing of gas stream 100 with fluid solvent 105, which may be liquid. Mixer 110 may be an inline static mixer, which may maximize mass transfer and produce gas-liquid mixture 130. Mixer 110 may be a tube or pipe with a series of baffles 160 along the interior. The number of baffles 160 in mixer 110 may vary depending on the desired extent of mixing and composition of streams to be mixed. Static mixer 110 may have the benefit of requiring no moving parts and therefore requiring no power to operate. The absence of moving parts may have the advantage of low energy consumption and low maintenance requirement. Static mixer 110 may also operate without an associated tank. As a result, the compact design of static mixer 110 may have the benefit of simple installation at the site of energy production as well as low up-front cost. Illustrative embodiments may employ one or more inline static mixers 110 to homogenize exhaust gas 100 post-combustion with fluid solvent 105 at greater than atmospheric pressure to maximize mass transfer and solubility of CO₂ within fluid solvent 105, which may greatly minimize energy consumption and footprint with minimal maintenance requirements. Gas-liquid mixture 130 may be a homogenous or substantially homogenous gas/liquid mixture formed from gas stream 100 and fluid solvent 105, when mixed, combined and/or homogenized by mixer 110.

In some embodiments, the pH of gas-liquid mixture 130 may be increased. In certain embodiments, the pH may be increased through rapid introduction of alkali caustic 120. Three illustrative examples of reactions to form bicarbonate or carbonate using alkali caustic 120 are as follows:

NaCl+2CO₂+Na(OH)+H₂O→HCl+2NaHCO₃

2NaCl+2CO₂+Ca(OH)₂→CaCl₂+2NaHCO₃

CO₂+2K(OH)→K₂CO₃+H₂O

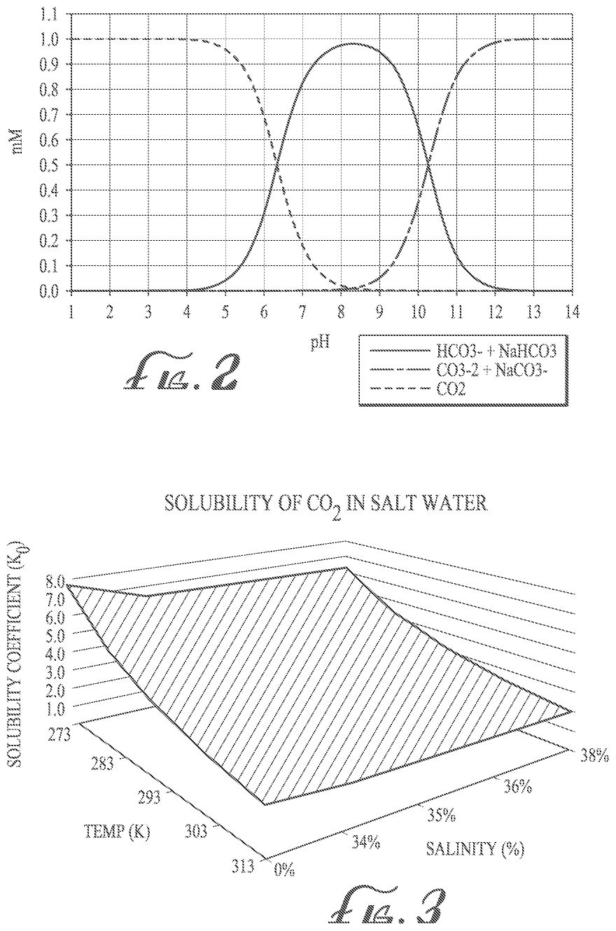

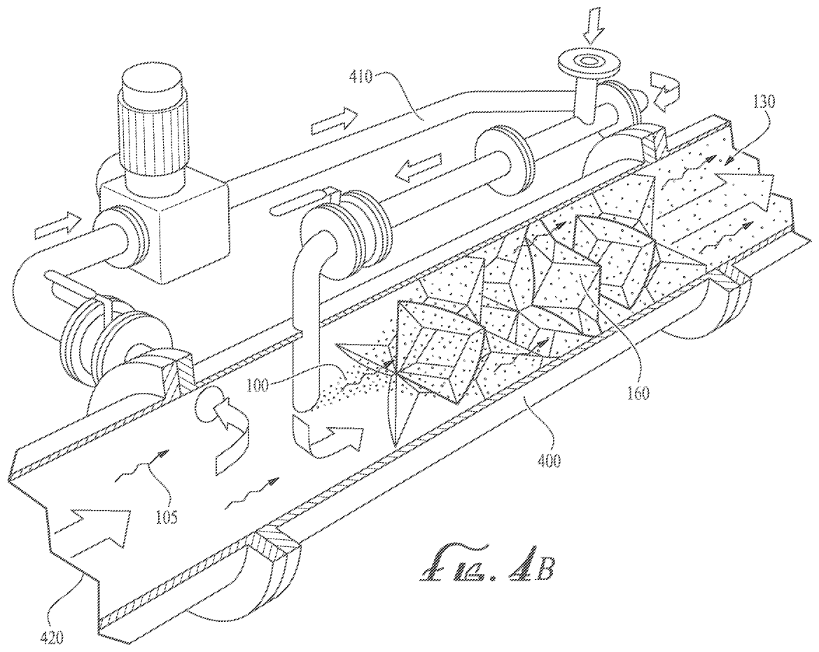

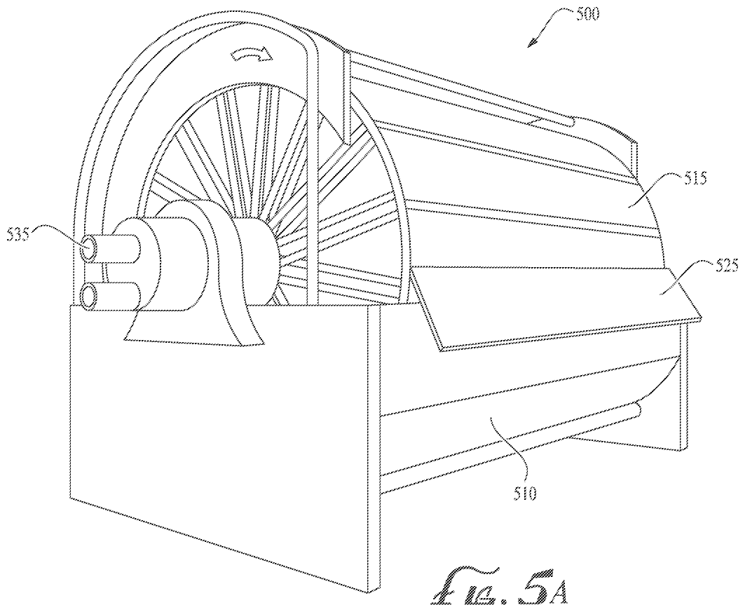

In certain embodiments, the pH of gas-liquid mixture 130 may be increased through electrolysis 125, without the need for alkali caustic 120. A direct electric current through gas-liquid mixture 130 may produce hydroxide ions at the cathode, thereby increasing the pH of gas-liquid mixture 130. The solution may then become basic due to the constant production of hydroxide through electrolysis 125. CO₂ in solution becomes bicarbonate as the pH of the solution becomes greater than 8 and may begin to precipitate out of solution, for example as illustrated in FIG. 2. Any pH above 10 and bicarbonate will desirably become carbonate. FIG. 2 illustrates the precipitation of carbonate and bicarbonate from gas-liquid mixture 130, as the pH increases. Gas-liquid mixture 130 may be moved to another vessel 165 or electrolysis 125 may be conducted in the post-baffles 160 portion of housing 400 (shown in FIGS. 4A and 4B), which may for example be a pipe. In some embodiments, a pH change may be induced with another static mixing element that introduces caustic 120 to the homogenous gas-liquid mixture 130. In certain embodiments, one of or both caustic 120 and electrolysis 125 may be employed to increase the pH of gas-liquid mixture 130 to above 10. Bicarbonate/Carbonate slurry 115 may be produced from gas-liquid mixture 130 as the pH increases, since bicarbonate may precipitate out of the basic solution. At pH's greater than 8, carbonate may be formed along with the bicarbonate in the aqueous mixture.

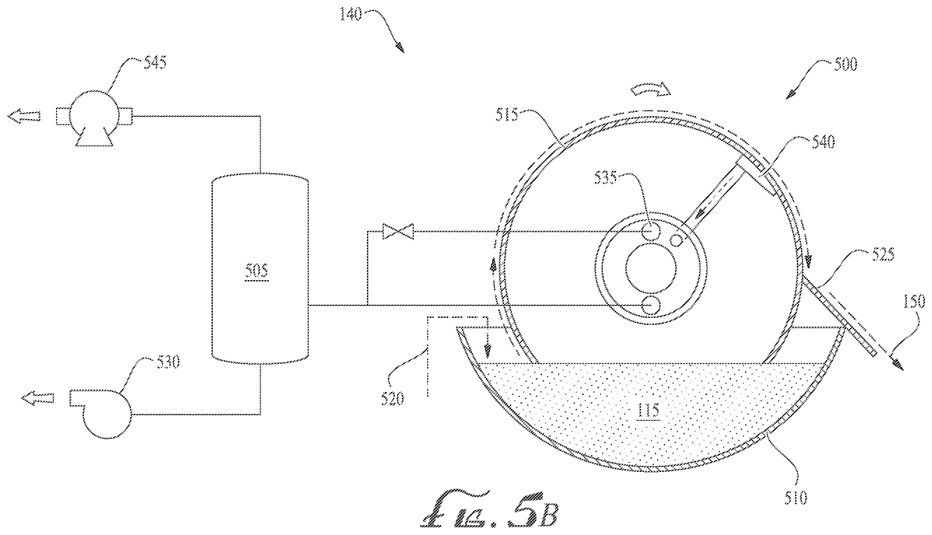

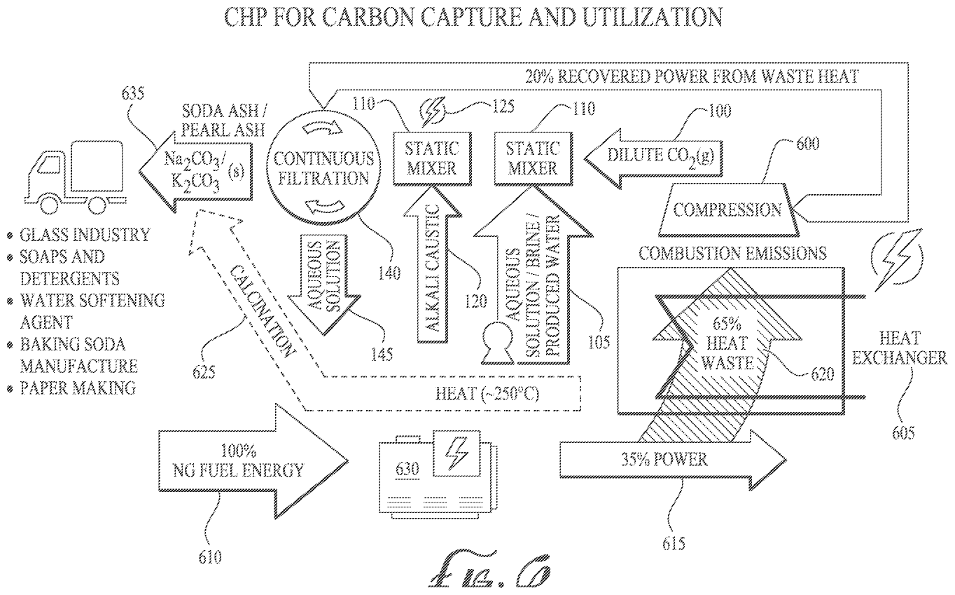

Bicarbonate/carbonate slurry 115 may then be continually separated and dewatered using continuous filtration system 140, such as rotary drum filter 500 (shown in FIG. 5A). Precipitate 150 in the saline slurry 115 may be extracted by a rotating vacuum drum 500 or another type of continuous filtration system 140. Precipitate 150 may consist of carbonate and/or bicarbonate. CO₂ free gas 135 may leave slurry 115 during filtration. The bicarbonate/carbonate-free aqueous solution 145, which may be a saline solution, an aqueous solution and/or a fluid solvent, may be disposed or recycled again to make additional sodium bicarbonate, as long as there are sufficient monovalent cations in solution to precipitate out with the carbonate.

Illustrative embodiments may improve a conventional Solvay process by switching out ammonia with alkali caustic 120, for example an alkaline earth metal caustic, such as calcium hydroxide (slaked lime) or an alkali caustic, such as sodium hydroxide (caustic soda) or potassium hydroxide (caustic potash). In some embodiments, neither ammonia nor alkali caustic 120 may be needed since electrolysis 125 may increase the pH of gas-liquid mixture 130 such that carbonate precipitate 150 may form. Therefore, the need for gaseous ammonia handling and regeneration may be eliminated while providing an even stronger basic pH due to the hydroxide replacement. In electrolysis 125 embodiments, fluid solvent 105 may be an aqueous solution containing salt to provide a cation for precipitate 150 formation. The key process of electrolysis 125 is the interchange of atoms and ions by the removal or addition of electrons due to the applied current. The reaction at the cathode results in hydrogen gas and hydroxide ions:

2H2O+2e−→H2+2OH—

Unlike a conventional electrolytic cell, illustrative embodiments may not require a partition between the electrodes but rather a semi-permeable membrane surrounding the anode only, may allow OH-ions produced at the cathode to freely diffuse throughout gas-liquid mixture 130 making the solution more basic without the use of any buffering agent or reagent.

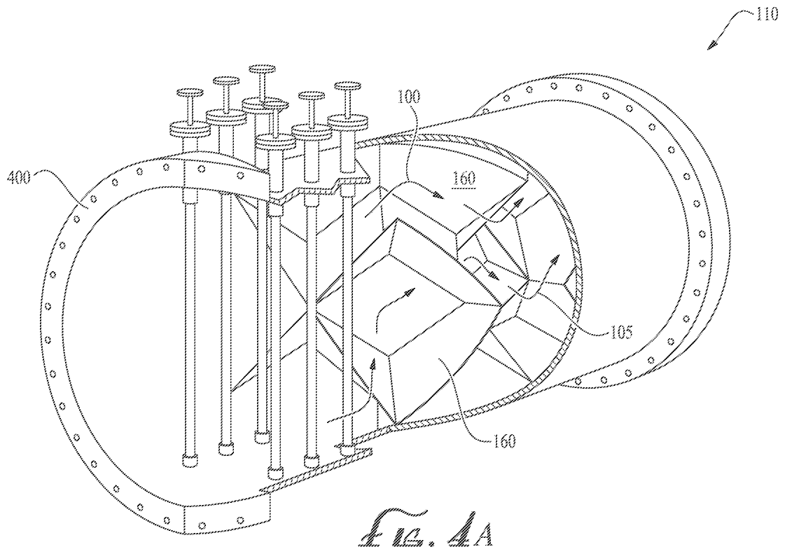

A traditional Solvay process bubbles a concentrated CO₂ stream through a buffered, high pH brine solution, but such conventional process may not be effective when applied to low concentration CO₂ found in post-combustion gas stream 100, such as less than 15% CO₂. Due to low CO₂ concentrations and reduced CO₂ solubility in high salinity conditions, there is a need to maximize the mass transfer between the high salinity solution and post-combustion exhaust gas or low concentration CO₂ gas. FIG. 3 illustrates the solubility of CO₂ in salt water. Maintaining a high pH in the solution may facilitate precipitation or removal of CO₂ already in solution, thereby increasing the mass transfer of CO₂ into solution based on Le Chatelier's Principle.

In some embodiments, bicarbonate/carbonate-free aqueous solution 145 may be recirculated and used as fluid solvent 105 and/or be combined with fluid solvent 105 to be mixed with dilute CO₂ gas stream 100. Aqueous solution 145 may be and/or remain at a high pH even after filtration, for example if electrolysis 125 assists in maintaining a high pH in the system and/or if alkali caustic 120 has been previously applied in excess. Therefore, in some embodiments an increase in pH after mixing of gas stream 100 and fluid solvent 105 may not be necessary. In certain embodiments, fluid solvent 105 may have a high pH upon mixing with gas stream 100, which high pH may be sufficient to induce formation of bicarbonate/carbonate slurry 155 without the need for post-homogenization electrolysis 125, post-homogenization introduction of alkali caustic 120 or other post-homogenization/post-mixing step to increase pH.

Static mixer 110 may be a precision-engineered, motionless mixing devices that may allow for the inline continuous blending of fluids within a pipeline. FIGS. 4A-4B illustrate static mixers of illustrative embodiments. With no moving parts, static mixer 110 may utilize the energy of the flow of stream 100 and/or fluid solvent 105 to generate consistent, cost-effective, and reliable mixing. In some embodiments, one or more fluid moving pumps may move, flow, pump and/or direct stream 100 and/or fluid solvent 105 into static mixer 110. Static mixer 110 may include a series of baffles 160 made of metal or a plastic, for example. Baffles 160 may be housed within housing 400, which may for example be a tube or pipe and may be made of metal or plastic, for example. The housed-elements design of static mixer 110 may provide a method for delivering two streams 100, 105 of fluids into the static mixer 110. As shown in FIG. 4B, static mixer 110 may include sidestream inlet 410 for delivery of gas stream 100 into housing 400, and may include intake 420 for delivery of fluid solvent 105 into housing 400. As the streams 100, 105 move through static mixer 110, the non-moving elements, such as baffles 160, may continuously blend the streams 100, 105 to form gas-liquid mixture 130. Complete mixing may depend on the fluids' properties, tube (housing 400) inner diameter, number of baffles 160 and their shape and/or design. The housed-elements (baffles 160) may be fixed in place and may simultaneously produce patterns of flow division and radial mixing. Baffles 160 may divide and recombine the feed streams 100, 105 so that gas-liquid mixture 130 stream exiting static mixer 110 may be homogeneous or substantially homogenous with regard to concentration, temperature and velocity which may be equalized throughout the entire housing 400 cross-section. Static mixing of a gas stream 100 and liquid stream of fluid solvent 105 into a homogenous gas-liquid mixture 130 may maximize mass transfer and may optimize solubility of the gas stream 100 containing dilute CO₂ into fluid solvent 105 without the need of towers or bubble columns or any other reactor vessels. FIG. 5B illustrates side stream inlet 410 enhancement for gas mixing/micro-bubble formation. The number and type of baffles 160 may determine the type and extent of mixing. Illustrative embodiments may provide a minimum mass transfer efficiency of 90% or above. In certain embodiments, a dynamic mixer (such as a motor with rotating blades) may be employed rather than static mixer 110.

A pH change may be introduced once optimal CO₂ solubility is achieved and precipitate 150 forms out of the solution. Any pH above 8 may drive carbon dioxide to form bicarbonate. This bicarbonate and/or carbonate slurry 115 may be continually filtered out, dewatered and the CO₂ free gas 135 may be allowed to leave the slurry 115 during the filtration process. The filtered, bicarbonate/carbonate-free solution 145 may be disposed or recycled again to make additional sodium bicarbonate, as long as there is sufficient monovalent cations in solution to precipitate out with the carbonate.

Fluid solvent 105 may be relatively inexpensive and readily available feedstock for the process of illustrative embodiments, whether from saline aquifers, produced water in the oil field, waste effluent from various industrial processes, or even fresh water or sea water. Sea water may contain dissolved carbon dioxide which may ultimately become part of the filter cake. This may have the benefit of removing excess carbon dioxide from sea water and may help decrease the acidity of the ocean and create an environment more conducive for shell-building invertebrates. Additionally, the CO₂ may be generated from the combustion process, e.g., from flue gas and/or exhaust.

An exemplary filtration system 140 of illustrative embodiments is shown in FIGS. 5A and 5B. Precipitate 150 may collect on the outside of filter drum 515, in the presence of a vacuum, as filter drum 515 rotates. Precipitate 150 may form cake and then be scraped off the filter before the cake-free portion of the drum 515 re-immerses back into the saline slurry 115. Slurry 115 may be pumped, moved, lifted and/or transferred into filtration system 140, which may for example be rotary drum filter 500 or another continuous filtration system. Pump 530 may control the rate filtrate leaving the rotary filter, and filter valve 535 may also provide additional control to the system by determining the extent of vacuum exerted onto filter drum 515 and the rate at which filtrate accumulates on drum 515. Additional system control may be applied to the flow of slurry 115 entering into vat 510 by controlling slurry feed rate based on the rate of precipitation 150 formation and filter cake removal from filter drum 515. Rotary drum filter 500 may consist of a rotating filter drum 515 housed inside of filter vat 510. Vacuum pump 545 may provide a vacuum inside of filter drum 515, with vacuum receiver 505 storing fluids removed by vacuum pump 545. In some embodiments, a “vacuum” may be any pressure below atmospheric pressure. The diameter of filter vat 510 may be larger than the diameter of filter drum 515 to provide a circumferential space therebetween for slurry 115 to enter into filter vat 510 through slurry feed 520. Precipitate 150 may be sodium carbonate, bicarbonate and/or another carbon-based solid. The composition of precipitate 150 may vary depending on the original composition of gas stream 100 and fluid solvent 105 and/or the pH of the solution.

When slurry 115 enters into the vacuum environment created inside of continuous filtration system 140, rotation of filter drum 515 may allow a layer of precipitate 150 to form on filter drum 515. Thickness of precipitate layer 150 may vary depending on the speed at which filter drum 515 rotates and the concentration of dissolved solids in the solution (slurry 515). Knife blade 525 may extend through filter vat 510 and intersect with filter drum 515 at an oblique angle. Knife blade 525 may scrape precipitate 150 off of the outside perimeter of filter drum 515 to collect cake (formed from precipitate 150) and clear precipitate 150 from drum 515. Precipitate 150 may slide down knife blade 525 and be discharged into storage. Storage may be an internal compartment 540 within drum 515 or may be an external storage container, such as storage container 155. As filter drum 515 continues to rotate, the cake-free portion of filter drum 515 may re-immerse into saline slurry 115 to continue the process. In some embodiments, one or more filtration systems 140 may be employed.

Once precipitate 150 is collected through filtration system 140, precipitate 150 may be heated to 250° C. and/or undergo calcination 625 (shown in FIG. 6) to produce ash 635 (shown in FIG. 6), which may be soda ash or pearl ash in illustrative embodiments. In some embodiments, the pH of precipitate 150 may be high enough (i.e., greater than about 11—see FIG. 2) such that precipitate is predominantly carbonate, and calcination step 625 may not be necessary.

Illustrative embodiments may eliminate the use of gaseous ammonia, may remove the need for a high pH buffered feed, may eliminate the need for limestone as a feedstock, may maximize the mass transfer between gas stream 100 and fluid solvent 105 in a liquid state, may eliminate the need for reactor vessels, and may remove CO₂ generated from the combustion process. Only a continuous filtration device 140 may be required to remove precipitate 150 from slurry 115, thereby producing one or more products that may be widely used: as an active pharmaceutical ingredient; as a major ingredient in soaps and detergents; as a fluxing agent in the manufacturing of glass; as an ingredient in the paper making industry, and/or as a feedstock for other fine chemicals. This process may also eliminate the need to regenerate a solvent, greatly reducing the parasitic energy requirement generally associated with many CO₂ capture technologies. The fluid solvent 105 may be a waste stream, destined for disposal already, but put to productive use as described herein.

In some embodiments, gas stream 100 may be compressed in order to reduce volume of gas stream 100 that needs to be processed, which may reduce the footprint of the post-combustion processes of illustrative embodiments (see compression 600 shown in FIG. 6). As one skilled in the art would understand Boyle's Law and Henry's Law, by increasing the exhaust gases, such as gas stream 100, to pressures greater than atmospheric and/or through compression, the volume of the exhaust can be reduced many-fold or an order of magnitude based on the simple equation of P₁V₁=P₂V₂. And higher partial pressure of the component gases due to increased pressure also increases individual gas solubility in solution, such as CO₂. When considering compression of gas stream 100, a cost benefit relationship between increasing compression costs with decreasing equipment costs due to reduced volume handling may be considered.

The solubility of CO₂ in aqueous solutions may be at least partially influenced by the ions in solution. More generically, increasing ionic strength (saltiness) decreases CO₂ solubility, as shown in FIG. 3. Increased pressure of the CO₂ gas stream 100 and subsequent higher partial pressure may counteract this decrease in CO₂ solubility. Additionally, while decreased CO₂ solubility with increasing ionic strength may be an issue for carbon sequestration within subsurface brines, this is not an issue for the proposed modified Solvay process of illustrative embodiments because the dilute CO₂ concentration in the flue gas stream 100 does not need to be concentrated for efficient storage purposes in the subsurface nor required for concentrating the CO₂ to high purity CO₂ for transportation purposes. Rather than fighting thermodynamics to concentrate a gas stream 100 that is inherently dilute in CO₂, the process of illustrative embodiments may leverage the low concentration of CO₂ in the flue gas as a feature for this wholistic approach to not only remove CO₂ from the post combustion process but also convert it to a commercially viable feedstock and product.

Producing a solid carbonate feedstock from CO₂ flue gas stream 100 may eliminate the tremendous equipment and energy required to concentrate, compress, and transport the purified CO₂ offsite. Additionally, because the carbon has been mineralized, there is no need to dehydrate the CO₂ post-purification for transport, thereby eliminating a required energy-intensive, dehydration process step associated with any CO₂ transportation.

FIG. 6 shows an illustrative embodiment of a system of wholistic carbon dioxide removal, waste heat recovery, and conversion of CO₂ to a commercial product. As shown in FIG. 6, natural gas or coal may be burned as fuel energy 610, to produce power 615 and waste heat 620. Waste heat 620 may be captured by heat exchanger 605 and may be recovered to power continuous filtration 140 and/or compression 600. Additionally or alternatively, waste heat 620 may be used to power a different process, such as calcination 625. Dilute gas stream 100 may be produced as a byproduct from combustion of fuel energy 610 such as natural gas, coal, or another fuel. In some embodiments, gas stream 100 may undergo compression 600 to reduce the footprint of the carbon capture and utilization system of illustrative embodiments. Dilute gas stream 100 and fluid solvent 105 may be homogenized and/or mixed in static mixer 110 to produce gas-liquid mixture 130. Once the gas-liquid mixture 130 is homogenized or substantially homogenized to maximize mass transfer, a current may be applied to initiate electrolysis 125 and/or an alkali caustic 120 may be applied to increase the pH of the solution to 8 or above and produce bicarbonate/carbonate slurry 115 where carbonate and/or bicarbonate may precipitate out of solution as precipitate 150. Continuous filtration system 140 may then remove precipitate 150, which may be heated and/or calcinated 625 to form ash 635, for example soda ash or pearl ash, and transported and/or sold as a commercial product, such as in the glass industry, in soaps and detergents, water softening agent, baking soda manufacture and/or paper making. A portion of waste heat 620 may be applied to encourage calcination 625 of bicarbonate, carbonate and/or precipitate 150 into ash 635, such as raising the temperature of gas-liquid mixture 130 and/or slurry 115 to 250° C., about 250° C. or at least 250° C.

Parasitic loss of power due to post-combustion carbon capture may be reduced or eliminated with a waste heat 620 recovery step. In some embodiments, high-temperature waste heat may be recovered from an engine 630, turbine, boiler, furnace, oven, kiln, or other thermal process and converted to electricity using a Rankine cycle steam turbine or another similar system. In certain embodiments, lower temperature waste heat may be recovered from thermal systems and processes and converted to electricity using the organic Rankine cycle coupled with turbines or reciprocating engines, or another similar technique. For example, an engine and/or turbine may be used to drive a mechanical shaft that, in turn, spins a compressor, pump, and/or electrical generators. In illustrative embodiments, a pipeline compressor station may use a gas turbine to drive a compressor to move natural gas through a pipeline. Low-temperature waste heat 620 may be recovered from the gas turbine exhaust, typically using organic Rankine cycle technology, and used to generate electricity. Such a device or waste heat recovery process may be fluidly coupled to the engine 630 or thermal exhaust, thereby reducing the temperature of the exhaust stream to an acceptable temperature to allow for subsequent capture of carbon dioxide post-combustion, while also providing additional energy that can be applied to subsequent steps of the process of illustrative embodiments, for example electrolysis 125 and/or compression 600.

A system and method for capture and utilization of carbon dioxide from dilute fluid streams has been described. Further modifications and alternative embodiments of various aspects of the invention may be apparent to those skilled in the art in view of this description. Accordingly, this description is to be construed as illustrative only and is for the purpose of teaching those skilled in the art the general manner of executing the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the scope and range of equivalents as described in the following claims. In addition, it is to be understood that features described herein independently may, in certain embodiments, be combined.

What is claimed is:

1. A carbon capture system, comprising:
a static mixer fluidly coupled to a dilute CO₂ stream and a fluid solvent, wherein the static mixer is configured to produce a homogenous mixture from the dilute CO₂ stream and the fluid solvent;
means for increasing the pH of the homogenous mixture to at least 8, thereby producing a slurry from the substantially homogenous mixture, the slurry comprising one of bicarbonate, carbonate or a combination thereof;
a filtration system applied to the slurry that recovers a precipitate from the slurry; and
a calcination system configured to convert the precipitate into an ash.

2. The carbon capture system of claim 1, wherein the dilute CO₂ stream comprises exhaust exiting a fuel gas combustion chamber.

3. The carbon capture system of claim 2, further comprising:
a compressor fluidly coupled to the static mixer; and
the compressor configured to compress the dilute CO₂ stream prior to entry into the static mixer.

4. The carbon capture system of claim 3, further comprising:
a heat engine coupled between the fuel gas combustion chamber and the compressor; and
wherein the heat engine extracts work from the dilute CO₂ stream to power the compressor.

5. The carbon capture system of claim 3, further comprising a heat recovery system coupled between the fuel gas combustion chamber and the compressor, wherein heat from the dilute CO₂ stream is used to calcinate the precipitate and form one of either soda ash or pearl ash.

6. The carbon capture system of claim 1, wherein the static mixer further comprises a housing and baffles dispersed within the housing.

7. The carbon capture system of claim 1, wherein the filtration system further comprises a rotary drum filter.

8. The carbon capture system of claim 1, wherein the means for increasing the pH of the homogenous mixture comprises an electrolysis system.

9. The carbon capture system of claim 1, wherein the means for increasing the pH of the homogenous mixture comprises adding an alkali caustic to the homogenous mixture.

10. The carbon capture system of claim 1, wherein the fluid solvent comprises one of fresh water, sea water, a salty aqueous solution, a brine or a combination thereof.

11. The carbon capture system of claim 1, wherein the ash comprises soda ash or pearl ash.

12. A method of capturing and utilizing carbon from a dilute post-combustion gas stream, comprising:
homogenizing in a static mixer a dilute CO₂ gas stream and a fluid solvent to produce a homogenized gas-liquid mixture;
applying an electric current to the homogenized gas-liquid mixture to increase a pH of the homogenized gas-liquid mixture and thereby produce a slurry comprising one of carbonate, bicarbonate, or a combination thereof;
filtering the one of carbonate, bicarbonate or a combination thereof from the slurry; and
calcinating the filtered carbonate, bicarbonate or the combination thereof to produce one of soda ash or pearl ash.

13. The method of claim 12, wherein the dilute CO₂ gas stream is produced from combustion of a carbon-based fuel to produce power.

14. The method of claim 13, wherein the combustion produces waste heat, and wherein the waste heat is applied to power the filtering.

15. The method of claim 14, wherein a heat engine applies the waste heat to power the filtering.

16. The method of claim 12, wherein the dilute CO₂ stream is compressed prior to homogenizing.

17. The method of claim 12, wherein the dilute CO₂ stream comprises exhaust from carbon-based fuel combustion, and further comprising extracting heat from the dilute CO₂ gas stream to power one of a compressor, a continuous filtration system, calcination, or a combination thereof.

18. The method of claim 12, further comprising utilizing a compressor to compress the dilute CO₂ gas stream prior to homogenizing the dilute CO₂ gas stream in the static mixer, and further comprising extracting heat from the dilute CO₂ gas stream to power the compressor.

19. The method of claim 12, wherein filtering the slurry produces a second fluid solvent, and further comprising recirculating the second fluid solvent into the static mixer.

20. The method of claim 12, wherein the filtering comprises:
extracting the one of carbonate, bicarbonate or the combination thereof from the slurry by using a rotating vacuum drum to form filter cake; and
converting the filter cake into one of soda ash or pearl ash.

21. The method of claim 12, wherein the fluid solvent comprises one of fresh water, salt water, sea water, brine or a combination thereof.

22. The method of claim 12, wherein the fluid solvent is a salty aqueous solution.

23. The method of claim 12, wherein the fluid solvent is fresh water.

24. A method of capturing and utilizing carbon from a post-combustion gas stream, comprising:
mixing the post-combustion gas stream with a brine in a static mixer;
increasing the pH of the post-combustion gas stream and the brine so mixed to produce a precipitate; and
filtering the precipitate from the mixture.

25. The method of claim 24, wherein increasing the pH comprises addition of an alkali caustic to the mixture.

26. The method of claim 24, wherein increasing the pH comprises applying electrolysis to the post-combustion gas stream and brine mixture.

27. The method of claim 26, wherein electrolysis comprises placing a semi-permeable membrane to surround an anode but not a cathode.

28. A carbon capture method, comprising:
mixing a dilute CO₂ stream and an aqueous solution to form a slurry, the slurry comprising one of bicarbonate, carbonate or a combination thereof;
filtering the slurry to form a precipitate and a filtrate from the slurry; and
calcinating the precipitate to convert the precipitate into an ash.

29. The carbon capture method of claim 28, wherein the aqueous solution has a high pH.

30. The carbon capture method of claim 28, further comprising recirculating the filtrate to combine with the aqueous solution.

31. The carbon capture method of claim 30, further comprising increasing the pH of the filtrate prior to recirculating the filtrate to combine with the aqueous solution.
